(19) United States
(12) Patent Application Publication
(10) Pub. No.: US 2010/0326097 A1
(43) Pub. Date: Dec. 30, 2010

(54) METHODS AND SYSTEMS FOR DENSIFYING A LIQUID FUEL USING A LIQUID NITROGEN BATH

(76) Inventors: Han V. Nguyen, Buena Park, CA (US); Martin E. Lozano, Whittier, CA (US)

Correspondence Address: JOHN S. BEULICK (24691);ARMSTRONG TEASDALE LLP, 7700 Forsyth Boulevard, Suite 1800, St. Louis, MO, 63105, US

(21) Appl. No.: 12/495,416

(22) Filed: Jun. 30, 2009

(51) Int. Cl. F25D 3/10; F17C 9/00; F17C 13/08

(52) U.S. Cl. 62/98; 62/50.1; 62/53.2; 62/430

(57) ABSTRACT

A method for densifying liquid methane is described. The method includes passing the liquid methane through a liquid nitrogen bath, self-pressurizing a container associated with the liquid nitrogen bath through boil off of the liquid nitrogen within the container, and regulating pressure within the liquid nitrogen container to maintain a boiling point of the liquid nitrogen above the triple point temperature of the liquid methane passing through the liquid nitrogen bath.

### BACKGROUND

The field of the invention relates generally to storage of propellant fuels, and more specifically, to methods and systems for densifying a liquid fuel using a liquid nitrogen bath.

One of the continuing problems for space vehicles and launch platforms is the size and weight of the fuel tanks associated with the vehicle. The large fuel tanks are needed to hold enough of the fuel to complete the vehicle mission. Most of the fuels used in these vehicles are liquefied, and therefore handling and storage of such fuels is a challenge.

There has been amount of interest recently in utilizing liquid methane as a launch vehicle fuel and has been proposed as a fuel for the lunar landers currently being developed. One reason for the recent interest in liquid methane as a fuel is the non-toxic nature of liquid methane as compared to, for example, hypergolic propellants Monomethyl Hydrazine, Hydrazine or Nitrogen Textroxide, all of which require special handling.

Liquid propellants such as liquid methane (a fuel) and liquid oxygen (an oxidizer) can be densified, allowing for additional propellant to be loaded into the spacecraft tanks as compared to non-densified propellants. Alternatively, fuel densification allows for a reduction in the size of a fuel tank for the same mass of useable fuel. However, densification of propellants is not without its challenges. Liquid oxygen can be densified using liquid nitrogen at atmospheric pressure because 1) the normal boiling point of the liquid nitrogen is below the normal boiling point of liquid oxygen and 2) the normal boiling point of liquid nitrogen is above the freezing point of liquid oxygen. However, the normal boiling point liquid nitrogen cannot be used to densify liquid methane because the freezing point of liquid methane is above the normal boiling point of the liquid nitrogen.

### SUMMARY

In one aspect, a method for densifying liquid methane is provided. The method includes passing the liquid methane through a liquid nitrogen bath, self-pressurizing a container associated with the liquid nitrogen bath through boil off of the liquid nitrogen within the container, and regulating pressure within the liquid nitrogen container to maintain a boiling point of the liquid nitrogen above the triple point temperature of the liquid methane passing through the liquid nitrogen bath.

In another aspect, a system for densifying liquid methane is provided. The system includes a liquid methane storage tank, a liquid nitrogen container comprising a pressure regulation valve fluidly coupled thereto, and a heat exchanger placed within the liquid nitrogen container and fluidly coupled to the liquid methane storage tank. The system is operable for passing the liquid methane from the liquid methane storage tank through the heat exchanger. The liquid nitrogen container is pressurized through boil off of liquid nitrogen within the liquid nitrogen container. The pressure regulation valve is configured to regulate pressure within the liquid nitrogen container such that a boiling point of the liquid nitrogen is maintained that is above the triple point temperature of liquid methane that is cooled by passing through the heat exchanger.

In still another aspect, an apparatus for densifying a first liquid is provided that includes a vessel operable for containing a second liquid, a heat exchanger substantially contained within the vessel that is operable for passing the first liquid therethrough, and a pressure regulation device for maintaining a specific pressure within the vessel. The pressure is generated through boil off of the second liquid, the specific pressure is maintained by the pressure regulation device such that the boil off temperature of the second liquid is above the triple point temperature of the first liquid.

In yet another aspect, a method for densifying a first liquid is provided that includes providing a vessel containing a second liquid, the second liquid at a boil off temperature, maintaining a pressure within the vessel, the pressure generated through the boil off of the second liquid, passing the first liquid through a heat exchanger substantially contained within the vessel to subcool the first liquid, the pressure maintained within the vessel maintained such that the boil off temperature is above the triple point temperature of the first liquid.

The features, functions, and advantages that have been discussed can be achieved independently in various embodiments of the present invention or may be combined in yet other embodiments further details of which can be seen with reference to the following description and drawings.

### BRIEF DESCRIPTION OF THE DRAWINGS

FIG. 1 is schematic illustration of a real time liquid methane densification system.

FIG. 2 is an illustration of the liquid methane densification system of FIG. 1 depicting a slow fill of a launch vehicle tank with liquid methane from a liquid methane storage facility.

FIG. 3 is an illustration of the liquid methane densification system of FIG. 1 depicting routing of the liquid methane through a densification unit as it passes from the liquid methane storage facility to the launch vehicle tank.

FIG. 4 is illustration of the liquid methane densification system of FIG. 1 depicting recirculation of the liquid methane from an overflow associated with the launch vehicle tank, through a densification unit, and back into the launch vehicle tank.

FIG. 5 is a flowchart illustrating a liquid methane densification process.

### DETAILED DESCRIPTION

The embodiments described herein relate to a method and system for densifying liquid methane (LCH₄) using a liquid nitrogen (LN₂) bath that is self-pressurized by boil off and pressure regulated above one atmosphere, for example, through venting, to maintain the liquid nitrogen boiling point temperature above the liquid methane triple point (TP) temperature. The described embodiments prevent the liquid methane from freezing. As such, the use of liquid nitrogen to densify liquid methane is enabled without causing the liquid methane to freeze, even though the one atmosphere normal boiling point (NBP) temperature of liquid nitrogen is below the triple point temperature of the liquid methane. The described system allows the normal boiling point liquid nitrogen to boil off and pressurize the liquid nitrogen bath to a level above one atmosphere.

Once the liquid nitrogen bath reaches the desired pressure, a relief valve is used to regulate and maintain the liquid nitrogen tank pressure at the desired level. The described embodiments do not require an active pressurization system, since they rely on self-pressurization and venting for tank pressure control, and there is an inherent safety in the described configurations because liquid nitrogen is not flammable in the presence of a fuel such as liquid methane. While the embodiments described herein utilize liquid methane as the substance to be densified, and liquid nitrogen as the substance used in the densification of the liquid methane, it should be understood that the embodiments may be utilized with fuel compositions other than liquid methane and with cooling compositions other than liquid nitrogen.

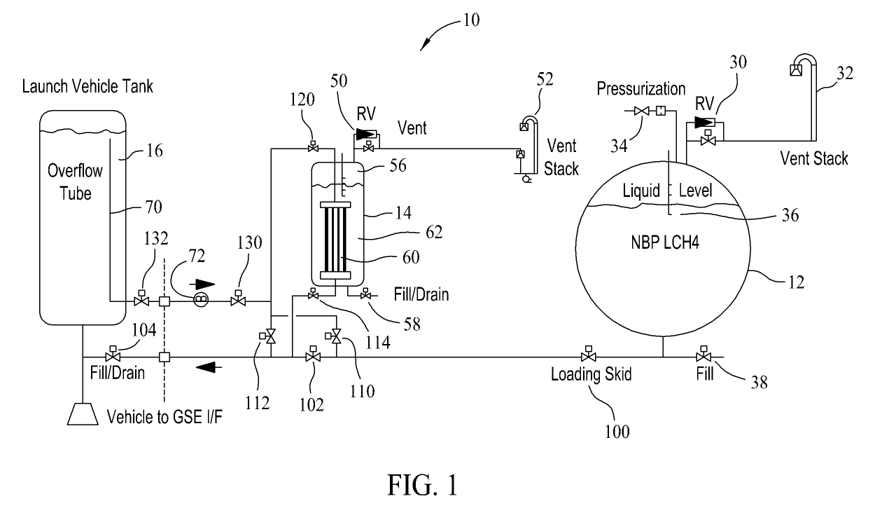

FIG. 1 is schematic illustration of a real time liquid methane densification system 10. The main components of system 10 include a facility storage tank 12 which maintains liquid methane at a normal boiling point, a densification unit 14 which maintains the liquid nitrogen and is configured to provide the liquid nitrogen bath for the liquid methane, and a tank 16 which holds the densified liquid methane. In one embodiment, tank 16 is a fuel tank for a launch vehicle.

Still referring to FIG. 1, facility storage tank 12 may include a relief valve 30 coupled to a vent stack 32, a pressurization valve 34, and liquid level sensors 36. Facility storage tank 12 is replenished through a fill valve 38.

Likewise, densification unit 14 includes a relief valve 50 coupled to a vent stack 52, liquid level sensors 56 and a fill valve 58. In one embodiment, and as explained further herein, relief valve 50 is configured with a set point which enables the densification unit 14 to maintain a specific pressure within the densification unit 14 as liquid nitrogen within the unit 14 boils off. Densification unit 14 also includes a heat exchanger 60 through which the liquid methane passes through. The heat exchanger 60 is substantially surrounded by a liquid nitrogen container 62. The liquid methane passes through the heat exchanger 60 to be cooled, and thus densified, due to the presence of the liquid nitrogen. As further explained herein, the liquid nitrogen is self pressurized through boil off within a liquid nitrogen container 62, and the liquid nitrogen is maintained at a specific pressure through venting of the liquid nitrogen container 62. The liquid nitrogen is maintained at a pressure which results in a temperature for the liquid nitrogen that is above the freezing point of the liquid methane, as further explained herein.

As shown in FIG. 1, depending on the setting of various valves within system 10, liquid methane may pass directly from facility storage tank 12 to tank 16 and such a process is sometimes referred to herein as a slow filling of tank 16. Continuing with the description of system 10, and explained with more detail in the following paragraphs, a plurality of valves are utilized to either allow the liquid methane to directly slow fill the tank 16, or route the liquid methane through the heat exchanger 60 of densification unit 14 as it moves from the facility storage tank 12 to the tank 16. In addition, tank 16 includes an overflow tube 70 which works in conjunction with a number of the above mentioned valves and a recirculation pump 72 to route liquid methane from the tank 16, through the heat exchanger 60 of the densification unit 14, and back into the tank 16.

Regulation of pressure within the liquid nitrogen container 62 of densification unit 14 is accomplished by venting the liquid nitrogen container 62 to such that the pressure within the container 62 maintains the liquid nitrogen at a boiling point temperature which is above the triple point temperature of the liquid methane. For example, when the liquid nitrogen container 62 is initially filled with the relief valve 50 open, the liquid nitrogen container 62 will contain normal boiling point liquid nitrogen. When the container 62 is filled to the proper level, the relief valve 50 is closed, and the pressure and saturation temperature within the container 62 rises to a level above the normal boiling point of the liquid nitrogen. As such, this increased liquid nitrogen temperature prevents freezing of the liquid methane that passes through the heat exchanger 60 of the densification unit 14. In one embodiment, pressure within the liquid nitrogen container 62 is regulated by determining when the pressure within the liquid nitrogen container 62 is at a desired level (such that the liquid nitrogen is above the triple point temperature of liquid methane), and maintaining that pressure utilizing relief valve 50 in fluid communication with the liquid nitrogen container 62.

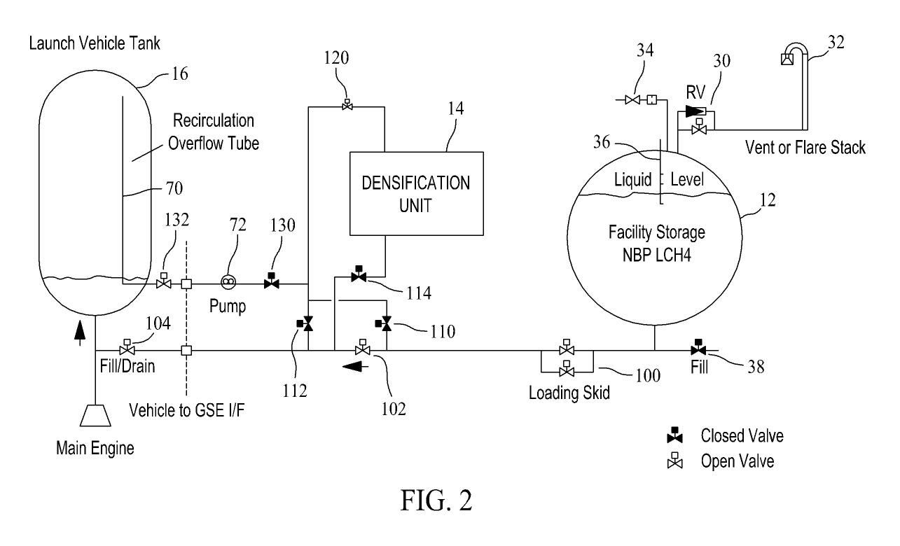

Now referring to FIG. 2, it is an illustration of the liquid methane densification system 10 depicting a slow fill of a launch vehicle tank 16 with liquid methane from liquid methane storage facility 12. For simplicity, components of the densification unit 14 associated with maintaining a pressure of the liquid nitrogen are not shown in FIG. 2 and subsequent figures. To slow fill the tank 16 from the facility storage tank 12, one or more loading skid valves 100 are opened allowing the liquid methane to move from the facility storage tank 12. A densification unit bypass valve 102 is also opened as is a vehicle tank fill/drain valve 104. It should be noted that densification unit valves 110, 112, and 114 are closed at this time so that none of the liquid methane is able to pass into the densification unit 14.

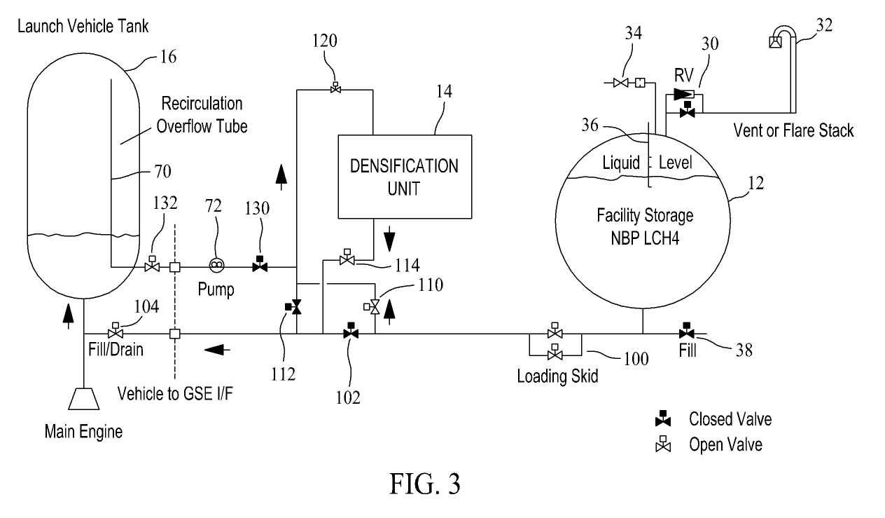

Now referring to FIG. 3, it is an illustration of the liquid methane densification system 10 depicting routing of the liquid methane through densification unit 14 as it passes from the liquid methane storage facility tank 12 to the launch vehicle tank 16. Bypass valve 102 is closed, loading skid valves 100 are opened, and densification unit valve 110 is opened allowing the liquid methane to be routed into the densification unit 14. Densification unit valve 112 is closed so that the liquid methane does not simply bypass the bypass valve 102 and continue on to the vehicle tank 16. Instead, the liquid methane passes through an opened densification unit entrance valve 120, through the densification unit 14, through densification unit valve 114, and on into the vehicle tank 16. It should be noted, that a pump output valve 130 is also closed so that the liquid methane does not pass through pump 72 and overflow tube 70 and into vehicle tank 16.

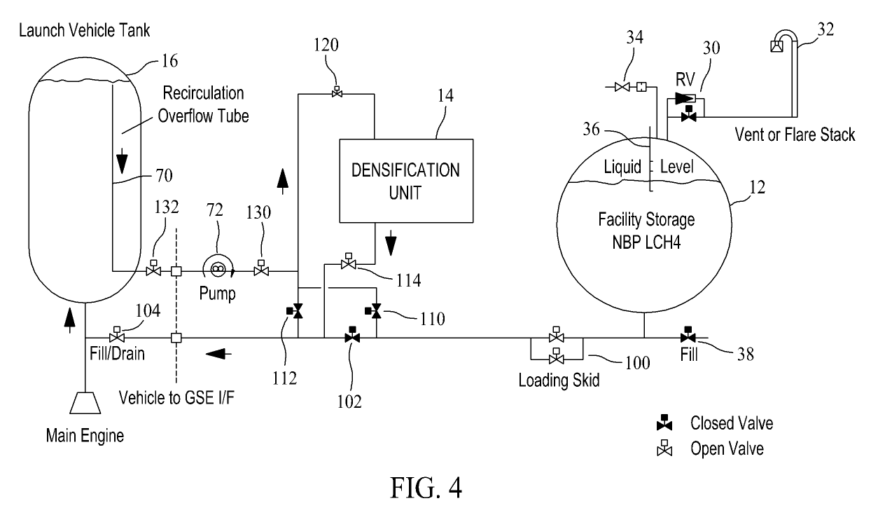

FIG. 4 is an illustration of the liquid methane densification system 10 depicting recirculation of the liquid methane from the overflow tube 70 associated with the launch vehicle tank 16, through densification unit 14, and back into the launch vehicle tank 16. Once the vehicle tank 16 is filled with liquid methane, as shown in FIG. 4, densification of the liquid is maintained, or increased, by recirculating the liquid methane through the densification unit 14. Specifically, a pump input valve 132 is opened allowing liquid methane to be drawn through overflow tube 70 by pump 72 and pumped through pump output valve 130 and densification unit entrance valve 120 and through densification unit 14. The densified liquid methane exits densification unit 14 and passes through densification unit valve 114 and vehicle tank fill/drain valve 104 and into vehicle tank 16. In this configuration bypass valve 102 is closed preventing the liquid methane from moving back towards the facility storage tank 12 and densification unit valves 110 and 112 are also closed ensuring that the liquid methane passes through the densification unit before it reenters the vehicle tank 16.

Summarizing, the process of real-time liquid methane densification is shown in FIGS. 2 through 4. In this process, the liquid methane, or other propellant, is subcooled during loading operations (FIG. 3) and recirculated to maintain conditions during ground hold (FIG. 4). FIG. 2 describes the initial slow fill of the vehicle tank 16 with normal boiling point liquid methane from the facility storage tank 16. FIG. 3 describes the liquid methane densified fill and FIG. 4 the recirculation of the liquid methane to maintain liquid methane subcooled conditions. FIG. 4 may be referred to as describing the liquid methane closed-loop densification.

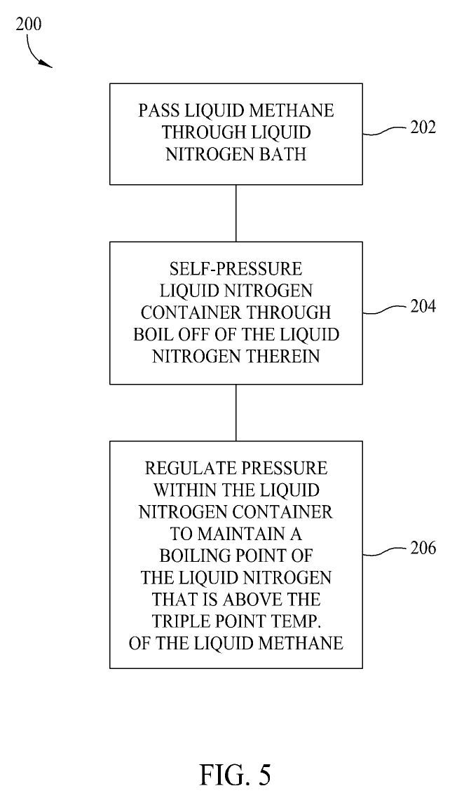

FIG. 5 is a flowchart 200 illustrating the liquid methane densification process described above with respect to FIGS. 2-4. Specifically, to densify the liquid methane, it is passed 202 through a liquid nitrogen bath. A container associated with the liquid nitrogen bath is self-pressurized 204 through boil off of the liquid nitrogen within the container, and pressure within the liquid nitrogen container is regulated 204 to maintain a boiling point of the liquid nitrogen above the triple point temperature of the liquid methane passing through the liquid nitrogen bath.

Once the liquid methane is placed within the vehicle tank 16, passing the liquid methane through a liquid nitrogen bath includes recirculating the liquid methane between the vehicle tank 16 and the liquid nitrogen bath associated with densification unit 14. While the vehicle tank is being filled passing the liquid methane through a liquid nitrogen bath includes passing the liquid methane through the liquid nitrogen bath associated with densification unit 14 as the liquid methane is routed from the storage facility tank 12 to a vehicle tank 16. When recirculating or filling, a flow rate of the liquid methane to the densification unit 14 that contains the liquid nitrogen bath is controlled.

In one embodiment and as described above, recirculating the liquid methane between the vehicle tank 16 and the liquid nitrogen bath associated with densification unit 14 includes utilizing the overflow tube 70 within vehicle tank 16 to accomplish the recirculation of the liquid methane between the vehicle tank 16 and a densification unit 14 that contains the liquid nitrogen bath.

As described above, regulating pressure within the liquid nitrogen container of densification unit 14 is accomplished by venting the liquid nitrogen container to maintain an elevated boiling point of the liquid nitrogen. This boiling point is above the triple point temperature of the liquid methane which also serves to prevent freezing of the liquid methane passing through the liquid nitrogen bath. Pressure within the liquid nitrogen container is regulated by determining when the pressure within the liquid nitrogen container within the liquid nitrogen bath is at a desired level, and maintaining the pressure at the desired level utilizing a relief valve in fluid communication with the liquid nitrogen container.

The above described embodiments provide a capability to densify liquid methane to a temperature of 165 degrees Rankine and achieve a liquid methane density increase of 6.5%. The embodiments utilize a liquid nitrogen bath to sub-cool the liquid methane from its normal boiling point of 201 degrees Rankine to a temperature of 165 degrees Rankine Since the liquid nitrogen normal boiling point of 139.24 degrees Rankine is lower than the liquid methane triple point temperature of 163.25 degrees Rankine, it is necessary to raise the liquid nitrogen bath temperature from its normal boiling point of 139.24 degrees Rankine to about 165 degrees Rankine. This rise in the temperature of the liquid nitrogen is accomplished by self-pressurizing the liquid nitrogen to 60 psia (pounds per square inch absolute), where the saturation temperature of the liquid nitrogen is 165 degrees Rankine. This pressure is maintained in the container of liquid nitrogen, and thus the temperature of the liquid nitrogen, in one embodiment, by cycling the liquid nitrogen tank relief valve 50 (shown in FIG. 1).

A thermodynamic state analysis has been performed to determine the operating conditions of the densification unit 14. The analysis has indicated that the liquid nitrogen bath pressure must be raised from ambient pressure to 60 psia to maintain the liquid nitrogen temperature at 165 degrees Rankine and prevent the liquid methane from freezing. At this temperature, the liquid methane will be subcooled by 36 degrees Rankine, and its density will increase by 6.5%.

The above described embodiments are anticipated to be useful as work progresses on space exploration and as entities plan for the use of liquid methane, or other densified liquid fuels as one of the fuels for a launch vehicle, or rocket, engine. The ability to densify a liquid fuel allows for the design and building of smaller fuel tanks, with lower operating tank pressures, which reduces the gross liftoff weight (GLOW) of a vehicle, leading to significant cost savings. Alternatively instead of smaller vehicles, vehicles with increased vehicle payload may be designed and built. Safety is increased because of a commonality in using a densification unit design based on free-boiling liquid nitrogen for both the oxidizer and the fuel. Higher engine safety and reliability also result with the ability to utilize liquid methane as a fuel as opposed to using densified liquid hydrogen.

This written description uses examples to disclose various embodiments, which include the best mode, to enable any person skilled in the art to practice those embodiments, including making and using any devices or systems and performing any incorporated methods. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method for densifying liquid methane, said method comprising:
passing the liquid methane through a liquid nitrogen bath;
self-pressurizing a container associated with the liquid nitrogen bath through boil off of the liquid nitrogen within the container; and
regulating pressure within the liquid nitrogen container to maintain a boiling point of the liquid nitrogen above the triple point temperature of the liquid methane passing through the liquid nitrogen bath.

2. A method according to claim 1 wherein passing the liquid methane through a liquid nitrogen bath comprises recirculating the liquid methane between a liquid methane tank and the liquid nitrogen bath.

3. A method according to claim 1 wherein passing the liquid methane through a liquid nitrogen bath comprises controlling a flow rate of the liquid methane between a liquid methane tank and a densification unit that contains the liquid nitrogen bath.

4. A method according to claim 1 wherein passing the liquid methane through a liquid nitrogen bath comprises passing the liquid methane through the liquid nitrogen bath as the liquid methane is routed from a storage facility to a vehicle tank.

5. A method according to claim 1 wherein passing the liquid methane through a liquid nitrogen bath comprises utilizing an overflow tube within a vehicle tank to recirculate the liquid methane between the vehicle tank and a densification unit that contains the liquid nitrogen bath.

6. A method according to claim 1 wherein regulating pressure within the liquid nitrogen container comprises venting the liquid nitrogen bath to maintain a boiling point of the liquid nitrogen above the triple point temperature of the liquid methane to prevent freezing of the liquid methane.

7. A method according to claim 1 wherein regulating pressure within the liquid nitrogen container comprises:
determining when the pressure within the liquid nitrogen bath is at a desired level; and
maintaining the pressure at the desired level utilizing a relief valve in fluid communication with the liquid nitrogen container.

8. A method according to claim 1 wherein passing the liquid methane through a liquid nitrogen bath comprises passing the liquid methane through a heat exchanger surrounded by the liquid nitrogen.

9. A system for densifying liquid methane, said system comprising:
a liquid methane storage tank;
a liquid nitrogen container comprising a pressure regulation valve fluidly coupled thereto; and
a heat exchanger placed within said liquid nitrogen container and fluidly coupled to said liquid methane storage tank, said system operable for passing the liquid methane from said liquid methane storage tank through said heat exchanger, said liquid nitrogen container pressurized through boil off of liquid nitrogen within said liquid nitrogen container, said pressure regulation valve configured to regulate pressure within said liquid nitrogen container such that a boiling point of the liquid nitrogen is maintained that is above the triple point temperature of liquid methane that is cooled by passing through said heat exchanger.

10. A system according to claim 9 further comprising:
a recirculation pump; and
a destination tank in fluid communication with said heat exchanger for end placement of the cooled liquid methane, said pump configured to pump liquid methane through said heat exchanger, and back into said destination tank.

11. A system according to claim 10 wherein said destination tank comprises an overflow tube in fluid communication with said recirculation pump, said pump configured to pump liquid methane, received via said overflow tube, through said heat exchanger, and back into said destination tank.

12. A system according to claim 9 further comprising a valve operable to control a flow rate of the liquid methane through said heat exchanger.

13. Apparatus for densifying a first liquid, said apparatus comprising:
a vessel operable for containing a second liquid;
a heat exchanger substantially contained within the vessel, said heat exchanger operable for passing the first liquid therethrough; and
a pressure regulation device for maintaining a specific pressure within said vessel, the pressure generated through boil off of the second liquid, the specific pressure maintained by said pressure regulation device such that the boil off temperature of the second liquid is above the triple point temperature of the first liquid.

14. Apparatus according to claim 13 further comprising a valve operable to control a flow rate of the first liquid through said heat exchanger.

15. Apparatus according to claim 13 further comprising:
a recirculation pump; and
a storage tank for the first liquid, said recirculation pump operable for pumping the first liquid from said storage tank, through said heat exchanger and back into said storage tank.

16. Apparatus according to claim 15 further comprising an overflow tube within said storage tank, said overflow tube in fluid communication with said recirculation pump.

17. Apparatus according to claim 13 wherein said pressure regulation device comprises a pressure relief valve.

18. A method for densifying a first liquid, said method comprising:
providing a vessel containing a second liquid, the second liquid at a boil off temperature;
maintaining a pressure within the vessel, the pressure generated through the boil off of the second liquid, and
passing the first liquid through a heat exchanger substantially contained within the vessel to subcool the first liquid, the pressure maintained within the vessel maintained such that the boil off temperature is above the triple point temperature of the first liquid.

19. A method according to claim 18 wherein passing the first liquid through a heat exchanger comprises routing the first liquid from a facility storage tank to a second tank via the heat exchanger.

20. A method according to claim 19 further comprising recirculating the first liquid entering an overflow tube within the second tank through the heat exchanger and back into the second tank.
